(19) United States
(12) Patent Application Publication
(10) Pub. No.: US 2011/0234540 A1
(43) Pub. Date: Sep. 29, 2011

(54) BACKGROUND IMAGE UPDATING METHOD AND TOUCH SCREEN

(75) Inventors: Chiou-Tzung LIOU, Sanchong City (TW); Ting-Hsuan Chang, Taipei City (TW); Ru-Yi Tsai, Banqiao City (TW); Tang-Wei Hsu, Taipei City (TW); Chia-Ho Chen, Kaohsiung City (TW)

(73) Assignee: Quanta Computer Inc., Tao Yuan Shien (TW)

(21) Appl. No.: 12/979,287

(22) Filed: Dec. 27, 2010

(30) Foreign Application Priority Data
Mar. 26, 2010 (TW) 099109255

(51) Int. Cl. G06F 3/042

(52) U.S. Cl. 345/175

(57) ABSTRACT

A background image updating method is adapted to a touch screen including a first and a second image modules. A first and a second images are captured by the first and the second image modules as a first and a second background images, respectively. (a) Whether an absolute value of a brightness difference between a third image captured by the first image module and the first background image is greater than a predetermine value is compared. (b) If the result of the step(a) is yes, whether an absolute value of a brightness difference between a fourth image captured by the second image module and the second background image is greater than another predetermine value is compared. (c) If the result of the step(b) is yes, a fifth and a sixth images are captured by the first and the second image modules as the first and the second background images, respectively.

### BACKGROUND IMAGE UPDATING METHOD AND TOUCH SCREEN

This application claims the benefit of Taiwan application Serial No. 099109255, filed Mar. 26, 2010, the subject matter of which is incorporated herein by reference.

### BACKGROUND OF THE INVENTION

1. Field of the Invention

The invention relates in general to a background image updating method and a touch screen, and more particularly to a background image updating method and a touch screen which provide an updating mechanism.

2. Description of the Related Art

With the rapid development of the technology, the use of touch screens is more and more common. According to the sensing principle, the touch screens can be divided into resistance touch screens, capacitance touch screens or ultrasonic touch screens. At present, optical touch screens has been further presented. Through comparing an object image and a background image, both captured by two image modules, a touch position is obtained. The background image is an image captured when no touch points or objects (including fingers or objects obstructing the light) are on the monitor, and the object image is an image captured when a touch point or an object is on the monitor. As the touch point is located in the light path, a dark point is generated in the object image. Afterwards, the background image and the object image are compared (according to the difference between the brightness thereof, for example) to determine the position of the touch point, and further to calculate the coordinate of the touch point with respect to the monitor. However, when the optical touch screen is impacted or shaken, the image modules disposed on the touch screen are moved at the same time. At this time, the images captured by the image modules may be distorted and twisted, so that other dark points may be generated or the position of the dark point is moved. Thus, the determination of the position of the touch point is inaccuracy.

For example, please refer to FIG. 1, an example of a background image captured by one of the image modules is shown. A background image M11 is captured when no objects touch the monitor. Please refer to FIG. 2A, an example of an object image captured by the image module is shown. Under the general situation, when an object or a finger touches the monitor, an object image M12 is, for example, captured by the image module as shown in FIG. 2A, and a slant line area in FIG. 2A represents a dark point mentioned above. As a result, the touch position of the object or the finger can be determined through the comparison of the background image M11 and the object image M12.

Please refer to FIG. 2B, an example of an object image captured by the image module when the monitor is warped is shown. While lifting or closing the monitor to a base of a portable electronic device, the monitor may be impacted to warp, an object image M13 is, for example, captured by the image module as shown in FIG. 2B. At this time, if the object image M13 and the background image M11 are compared to determine the touch position of the object, an error in determining is generated easily (for example, the position where the brightness varies obviously does not correspond to the position of the touch point). In addition, if the monitor is placed in different places (for example, the touch screen is moved to outdoors from indoors), an error in determining is also generated easily. Thus, how to provide a mechanism to timely update the background image to increase the accuracy in determining the touch position has become one of main issues for the related manufacturers.

### SUMMARY OF THE INVENTION

The invention is directed to a background image updating method and a touch screen. The brightness variation is used as a mechanism to determine whether a background image is updated or not, so that the accuracy in determining the touch position can be increased.

According to the present invention, a background image updating method adapted to a touch screen is provided. The touch screen includes a display module, a first image module and a second image module. A first image is captured by the first image module as a first background image. A second image is captured by the second image module as a second background image. The background image updating method includes following steps: (a) comparing whether an absolute value of a difference between a brightness of a third image captured by the first image module and a brightness of the first background image is greater than a first predetermined value; (b) if the result of the step(a) is yes, comparing whether an absolute value of a difference between a brightness of a fourth image captured by the second image module and a brightness of the second background image is greater than a second predetermined value; (c) if the result of the step(b) is yes, using the first image module to capture a fifth image, and using the second image module to capture a sixth image; and (d) using the fifth image to replace the first image as the first background image, and using the sixth image to replace the second image as the second background image.

According to the present invention, a touch screen is further provided. The touch screen includes a display module, a first image module, a second image module and a processor. The first image module disposed at a corner of the display module is for capturing a first image as a first background image. The second image module disposed at another corner of the display module is for capturing a second image as a second background image. The processor includes a program which is for performing the background image updating method mentioned above and is not repeatedly described herein.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (Prior Art) shows an example of a background image captured by one of the image modules.

FIG. 2A (Prior Art) shows an example of an object image captured by the image module.

FIG. 2B (Prior Art) shows an example of an object image captured by the image module when the monitor is warped.

FIG. 3 shows a flow chart of a background image updating method according to a preferred embodiment of the present invention.

FIG. 4A shows a touch screen using the background image updating method in FIG. 3.

FIG. 4B shows a block diagram of the touch screen in FIG. 4A.

FIGS. 5A and 5B show examples of the relation between the brightness and the location of the first image and the second image, respectively.

FIGS. 6A and 6B show examples of the relation between the brightness and the location of the third image and the fourth image, respectively.

FIGS. 7A and 7B show other examples of the relation between the brightness and the location of the third image and the fourth image, respectively.

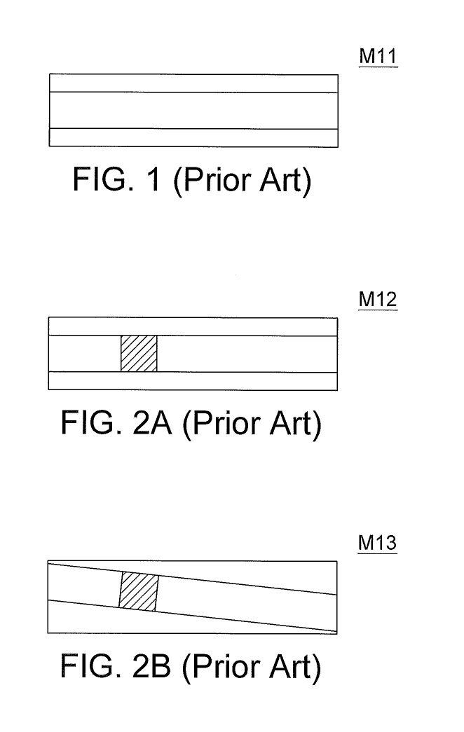

### DETAILED DESCRIPTION OF THE INVENTION

Embodiments of a background image updating method and a touch screen according to the present invention are illustrated in detail with reference to the accompanying drawings. However, a person having ordinary skill in the art should understand that the drawings and the content are for illustration only, and the present invention is not limited thereto.

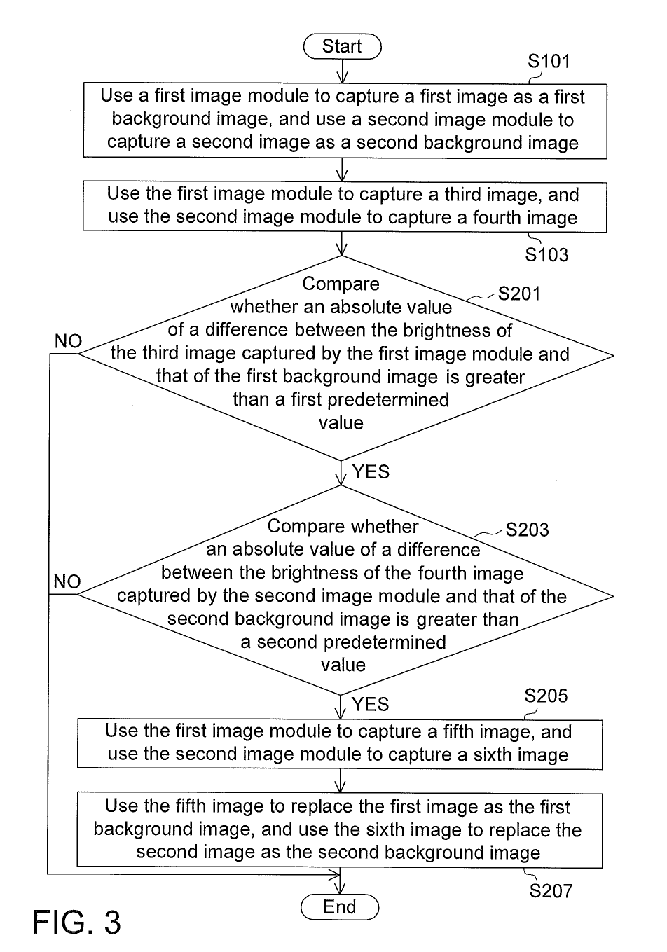

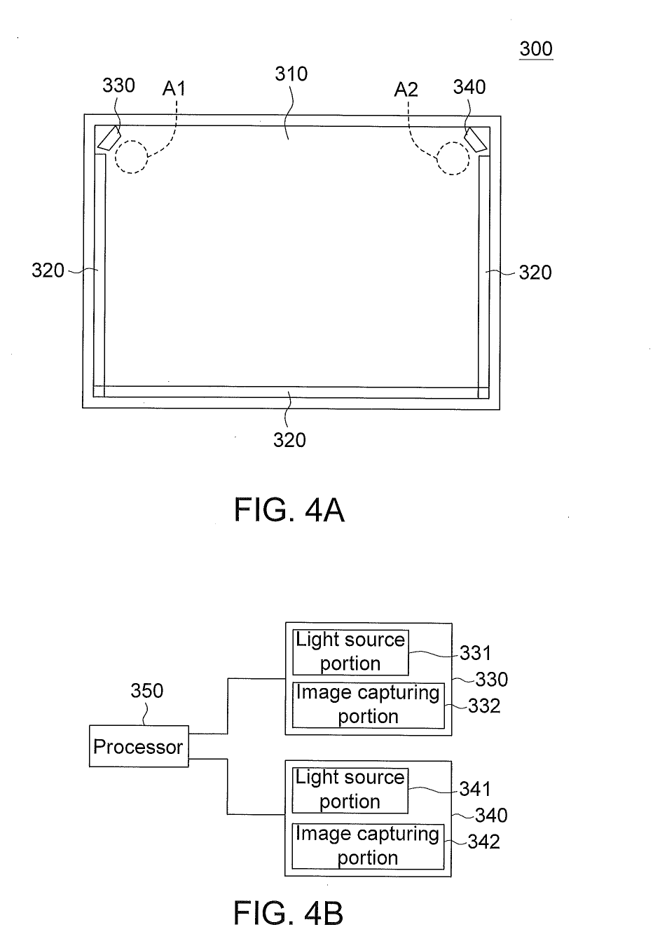

Please refer to FIG. 3, FIG. 4A and FIG. 4B concurrently, a flow chart of a background image updating method according to a preferred embodiment of the present invention is shown in FIG. 3, a touch screen using the background image updating method in FIG. 3 is shown in FIG. 4A, and a block diagram of the touch screen in FIG. 4A is shown in FIG. 4B.

In the present embodiment of the invention, a background image updating method is, for example, illustrated by using a touch screen 300 in FIG. 4A and FIG. 4B. The touch screen 300 includes a display module 310, several reflectors 320, a first image module 330, a second image module 340 and a processor 350. The reflectors 320 are disposed at three inner sides of the display module 310. The first image module 330 and the second image module 340 are disposed at two corners of the display module 310, respectively. The processor 350 includes a program for performing the background image updating method in FIG. 3.

The first image module 330 of the present embodiment includes a light source portion 331 and an image capturing portion 332, and the second image module 340 of the present embodiment includes a light source portion 341 and an image capturing portion 342. The image capturing portions 332 and 342 are used to capture the light, emitted by the light source portions 331 and 341, reflected by the reflectors 320, and thus a background image without touch points or an object image with touch points is generated. When the touch screen 300 is turned on, images are captured by the image capturing portions 332 and 342 at a predetermined capturing frequency, such as 20, 30 or 60 image/frame per second. The capturing frequency can be determined or preset according to the practical requirements.

The background image updating method of the present embodiment includes the following steps. In the step S101, when no touch points are on the display module 310, a first image is captured by the image capturing portion 332 of the first image module 330 as a first background image, and a second image is captured by the image capturing portion 342 of the second image module 340 as a second background image. Moreover, the first image and the second image are stored in a storage unit of the touch screen 300. The storage unit can be an individual component or built in the processor 350.

Then, the step S103 is preformed. In the step S103, the image capturing portions 332 and 342 continually capture images at the capturing frequency so as to respectively capture a third image and a fourth image, for example.

After that, the step S201 is performed. In the step S201, whether an absolute value of a difference between the brightness of the third image captured by the first image module 330 and the brightness of the first background image is greater than a first predetermined value is compared by the processor 350.

If the result of the step S201 is yes, the step S203 is performed. In the step S203, whether an absolute value of a difference between the brightness of the fourth image captured by the second image module 340 and the brightness of the second background image is greater than a second predetermined value is compared by the processor 350.

If the result of the step S203 is yes, the absolute value of the difference between the brightness of the third image and the brightness of the first background image is greater than the first predetermined value, and the absolute value of the difference between the brightness of the fourth image and the brightness of the second background image is greater than the second predetermined value. At this time, the step S205 is then performed by the processor 350. In the S205, the first image module 330 is controlled by the processor 350 to capture a fifth image, and the second image module 340 is controlled by the processor 350 to capture a sixth image. In detail, when the difference between the brightness of the third image and the brightness of the first background image is greater than a certain value, and the difference between the brightness of the fourth image and the second background image is greater than a certain value, the processor 350 determines that the display module 310 is under the warping state. In other words, the fifth image and the sixth image are images captured when the first image module 330 and the second image module 340 are moved or the display module 310 is under the warping state.

After the step S205, the step S207 is performed. In the step S207, through the processor 350, the fifth image is used to replace the first image as the first background image, and the sixth image is used to replace the second image as the second background image. At this time, the background image has been updated.

In addition, if the result of the step S201 is no, that is, the absolute value of the difference between the brightness of the third image and the brightness of the first background image is less than the first predetermined value, the step of updating the background image does not have to be performed. Thus, the background image updating method of the embodiment is terminated.

Similarly, if the result of the step S203 is no, that is, the absolute value of the difference between the brightness of the fourth image and the brightness of the second background image is less than the second predetermined value, the step of updating the background image does not have to be performed. Thus, the background image updating method of the embodiment is terminated.

After the background images are updated, the image capturing portions 332 and 342 continually capture new images at the capturing frequency. Through the processor 350, the new images respectively captured by the image capturing portions 332 and 342 are compared with the updated first background image (i.e. the fifth image) and the updated second background image (i.e. the sixth image) so as to calculate the position of the touch point. Due to the updated first background image (i.e. the fifth image) and the updated second background image (i.e. the sixth image) being captured when the first image module 330 or the second image module 340 is moved or the display module 10 is under the warping state, and the new images also being captured when the first image module 330 or the second image module 340 is moved or the display module 310 is under warping state, all of the images are captured and compared under the same state, so that the error rate or misjudgement can be reduced.

It is noted that the order of performing the step S201 and the step S203 can be switched, that is, the step S203 can be performed firstly, and the step S201 is performed according to the result of the step S203. In addition, the fifth image can be used to replace the first image directly after being captured, and the sixth image is then captured to replace the second image in the step S207.

As shown in the flow chart of the background image updating method, if the background images are intended to be updated, the conditions that the absolute value of the difference between the brightness of the third image and the brightness of the first background image is greater than the first predetermined value, and the absolute value of the difference between the brightness of the fourth image and the brightness of the second background image is greater than the second predetermined value have to be satisfied. In one embodiment, the conditions can be satisfied by using a finger or other objects.

When a finger or an object is, for example, positioned at the position A1 as shown in FIG. 4A, the light source portion 331 of the first image module 330 is obstructed. As the finger or the object positioned at the position A1 is quite close to the light source portion 331, the reflection of the light is extremely severe, thus the reflection is directly emitted into the image capturing portion 332. Therefore, the brightness of the image (such as the third image) captured by the image capturing portion 332 is greater than that of the first background image (which makes the absolute value of the difference is greater than the first predetermined value). Similarly, when the finger or the object is, for example, positioned at the position A2 as shown in FIG. 4A, the light source portion 341 of the second image module 340 is obstructed. As the finger or the object positioned at the position A2 is quite close to the light source portion 341, the reflection of the light is extremely severe, thus the reflection is directly emitted into the image capturing portion 342. Therefore, the brightness of the image (such as the fourth image) captured by the image capturing portion 342 is greater than that of the second background image (which makes the absolute value of the difference is greater than the second predetermined value). As a result, the conditions of the background image updating method are satisfied. It is noted that the reason why both of the step S201 and the S203 have to be satisfied concurrently is to filter user's unintentional action to reduce the error in determining whether to update the background images. For example, once either the step S203 or the step S205 is satisfied to activate the step of updating the background images, it results in inconvenience for the user because the condition is easily satisfied even during user's unintentional action or operation.

In practice, when the user notices that the coordinate of the touch point calculated by the processor 350 of the touch screen 300 is shift or inaccurate, it may results from the move of the first image module 330 or the second image module 340 being impacted, or the warp of the display module 310. At this time, the user can manually put his fingers or objects close to the light source portions 331 and 341 to obstruct at the same time, so that the first background image and the second background image are forced to update according to the background image updating method of the present embodiment. Therefore, the accuracy in determining the coordinate of the touch point can be increased. In addition, according to the practical operation experience, when the display module 310 is impacted or shaken, the brightness of the third image is usually greater than that of the first background image (which may make the absolute value of the difference is greater than the first predetermined value), and the brightness of the fourth image is also greater than that of the second background image (which may make the absolute value of the difference is greater than the second predetermined value). In other words, the touch screen 300 can also automatically update the first background image and the second background image. In summary, the update of the first background image and the second background image can be performed either automatically or manually in the present embodiment. If the user notices that the coordinate of the touch point is shift or inaccuracy but the touch screen 300 does not update the background image automatically, the background image can be updated manually. In addition, another difference between the automatic update and the manual update is that when the background images are updated manually, the finger or the object has to be moved away from the light source portions 331 and 341 after the step S203, so that the S205 is performed successively.

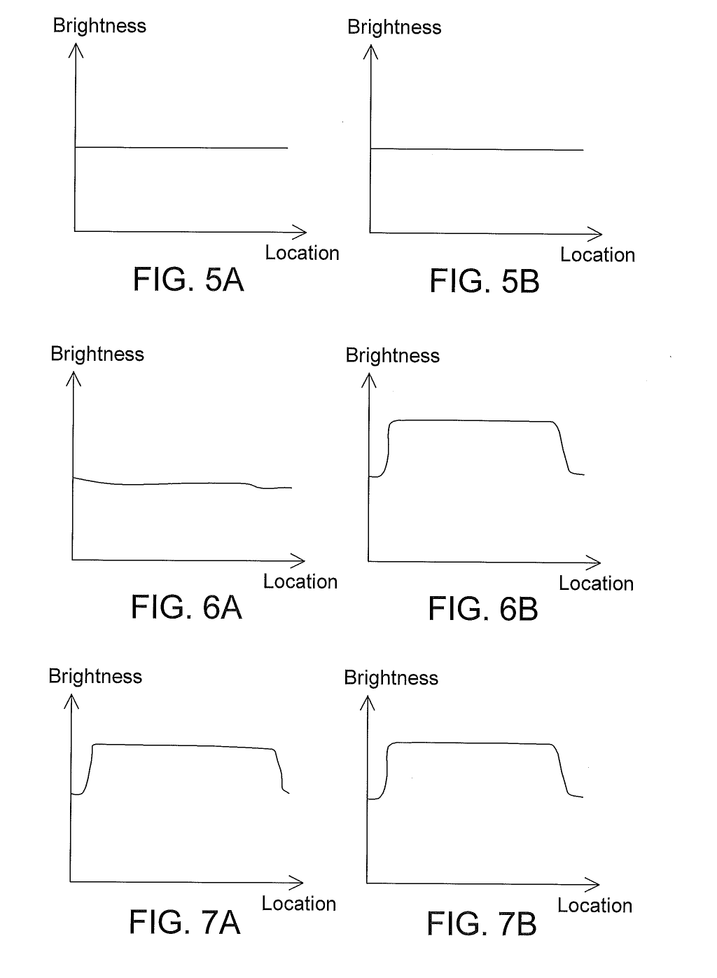

An example of the background image updating method according to the present embodiment is illustrated in the following. Please refer to FIGS. 5A and 5B, examples of the relation between the brightness and the location of the first image and the second image are respectively shown. Assume that the relation of the brightness and the location of the first image being the first background image is shown in FIG. 5A, and the relation of the brightness and the position of the second image being the second background image is shown in FIG. 5B.

Please refer to FIGS. 6A and 6B, examples of the relation between the brightness and the location of the third image and the fourth image are respectively shown. The relation of the brightness and the location of the third image shown is in FIG. 6A and that of the fourth image shown is in FIG. 6B. If the absolute value of the difference between the brightness of the third image in FIG. 6A and that of the first background image in FIG. 5A is less than the first predetermined value, the background image updating method is terminated. Even the absolute value of the difference between the brightness of the fourth image in FIG. 6B and that of the second background image in FIG. 5B is greater than the second predetermined value, the background image updating method is still terminated. That is to say, the coordinate of the touch point would be calculated by the processor 350 as normal through the comparison between the third image in FIG. 6A and the first background image and the comparison between the fourth image in FIG. 6B and the second background image.

In addition, please refer to FIG. 7A and FIG. 7B, other examples of the relation between the brightness and the location of the third image and the fourth image are respectively shown. When the user puts fingers or objects at the positions A1 and A2 shown in FIG. 4A at the same time, the relation of the brightness and the location of the third image is shown in FIG. 7A, and the relation of the brightness and the location of the fourth image is shown in FIG. 7B. At this time, the absolute value of the difference between the brightness of the third image in FIG. 7A and that of the first background image in FIG. 5A is greater than the first predetermined value, and the absolute value of the difference between the brightness of the fourth image in FIG. 7B and that of the second background image in FIG. 5B is greater than the second predetermined value. Thus, the step S205 and the step S207 are further performed by the processor 350, so that the fifth image is captured by the first image module 330 as the first background image, and the sixth image is captured by the second image module 340 as the second background image. Then, the new images captured after the updating steps by the image capturing portions 332 and 342 are compared with the updated first background image (i.e. the fifth image) and the updated second background image (i.e. the sixth image), so that the position of the touch point is calculated. Therefore, the accuracy in determining the touch position can be increased.

In one embodiment, in the step S201, the first predetermined value is set as 10%˜15% of the absolute value of the difference between a brightness summation of all pixels or pixels in a particular area of the third image and that of the first background image, and in the step S203, the second predetermined value is set as 10%˜15% of the absolute value of the difference between a brightness summation of all pixels or pixels in a particular area of the fourth image and that of the second background image. However, in the step S201, the first predetermined value for comparison can also be set as 10%˜15% of the absolute value of the difference between the average brightness of all the pixels or the pixels in the particular area of the third image and that of the first background image, and in the step S203, and the second predetermined value for comparison can also be set as 10%˜15% of the absolute value of the difference between the average brightness of all the pixels or the pixels in the particular area of the fourth image and that of the second background image. It have to be noted that the first determined value could be the same as the second determined value or different.

According to the background image updating method and the touch screen illustrated in the embodiment of the present invention, the first background image and the second background image are updated based on both the comparison between the third image and the first background image and the comparison between the fourth image and the second background image. Therefore, even the first image module and the second image module is moved to be placed in another environment, the user still can manually obstruct both the light source portions through the fingers or the object at the same time. Thus, the first background image and the second background image can timely be updated so as to increase the accuracy in determining the touch positions. In addition, as the touch screen is shaken or moved, the brightness of the third image and that of the fourth image are also increased concurrently, so that the first background image and the second background image can be updated automatically.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A background image updating method adapted to a touch screen, wherein the touch screen comprises a display module, a first image module and a second image module, a first image is captured by the first image module as a first background image, a second image is captured by the second image module as a second background image, and the background image updating method comprises following steps:
(a) comparing whether an absolute value of a difference between a brightness of a third image captured by the first image module and a brightness of the first background image is greater than a first predetermined value;
(b) if the result of the step(a) is yes, comparing whether an absolute value of a difference between a brightness of a fourth image captured by the second image module and a brightness of the second background image is greater than a second predetermined value;
(c) if the result of the step(b) is yes, using the first image module to capture a fifth image, and using the second image module to capture a sixth image; and
(d) using the fifth image to replace the first image as the first background image, and using the sixth image to replace the second image as the second background image.

2. The background image updating method according to claim 1, further comprising:
(e) if the result of the step(a) is no, terminating the background image updating method; and
(f) if the result of the step(b) is no, terminating the background image updating method.

3. The background image updating method according to claim 2, wherein in the step(a), when the absolute value of the difference between a brightness summation of all pixels or pixels in a particular area of the third image and a brightness summation of all pixels or pixels in a particular area of the first background image is greater than the first predetermined value, or the absolute value of the difference between an average brightness of all the pixels or the pixels in the particular area of the third image and an average brightness of all the pixels or the pixels in the particular area of the first background image is greater than the first predetermined value, the result of the step(a) is yes.

4. The background image updating method according to claim 3, wherein in the step(b), when the absolute value of the difference between a brightness summation of all pixels or pixels in a particular area of the fourth image and a brightness summation of all pixels or pixels in a particular area of the second background image is greater than the second predetermined value, or the absolute value of the difference between an average brightness of all the pixels or the pixels in the particular area of the fourth image and an average brightness of all the pixels or the pixels in the particular area of the second background image is greater than the second predetermined value, the result of the step(b) is yes.

5. The background image updating method according to claim 2, wherein in the step(a), when the absolute value of the difference between the brightness of the third image captured by the first image module and the brightness of the first background image is greater than 10%˜15%, the result of the step(a) is yes, and in the step(b), when the absolute value of the difference between the brightness of the fourth image captured by the second image module and the brightness of the second background image is greater than 10%˜15%, the result of the step(b) is yes.

6. A touch screen, comprising:
a display module;
a first image module disposed at a corner of the display module for capturing a first image as a first background image;
a second image module disposed at another corner of the display module for capturing a second image as a second background image; and
a processor comprising a program, wherein the program is for performing a background image updating method, and the program comprises:
a first instruction for comparing whether an absolute value of a difference between a brightness of a third image captured by the first image module and a brightness of the first background image is greater than a first predetermined value;
a second instruction, wherein when the result of the first instruction is yes, the second instruction is for comparing whether an absolute value of a difference between a brightness of a fourth image captured by the second image module and a brightness of the second background image is greater than a second predetermined value; and
a third instruction, wherein when the result of the second instruction is yes, the third instruction is for controlling the first image module to capture a fifth image to replace the first image as the first background image, and controlling the second image module to capture a sixth image to replace the second image as the second background image.

7. The touch screen according to claim 6, wherein the program further comprises:
a fourth instruction, wherein if the result of the first instruction is no, the background image updating method is terminated; and
a fifth instruction, wherein if the result of the second instruction is no, the background image updating method is terminated.

8. The touch screen according to claim 7, wherein when the absolute value of the difference between a brightness summation of all pixels or pixels in a particular area of the third image and a brightness summation of all pixels or pixels in a particular area of the first background image is greater than the first predetermined value, or the absolute value of the difference between an average brightness of all the pixels or the pixels in the particular area of the third image and an average brightness of all the pixels or the pixels in the particular area of the first background image is greater than the first predetermined value, the result of the first instruction is yes.

9. The touch screen according to claim 8, wherein when the absolute value of the difference between a brightness summation of all pixels or pixels in a particular area of the fourth image and a brightness summation of all pixels or pixels in a particular area of the second background image is greater than the second predetermined value, or the absolute value of the difference between an average brightness of all the pixels or the pixels in the particular area of the fourth image and an average brightness of all the pixels or the pixels in the particular area of the second background image is greater than the second predetermined value, the result of the second instruction is yes

10. The touch screen according to claim 7, wherein when the absolute value of the difference between the brightness of the third image captured by the first image module and the brightness of the first background image is greater than 10%˜15%, the result of the first instruction is yes, and when the absolute value of the difference between the brightness of the fourth image captured by the second image module and the brightness of the second background image is greater than 10%˜15%, the result of the second instruction is yes.
